(19) United States
(12) Patent Application Publication
(10) Pub. No.: US 2025/0184323 A1
(43) Pub. Date: Jun. 5, 2025

(54) SYSTEMS AND METHODS FOR SECURE ACCESS OF STORAGE

(71) Applicant: Capital One Services, LLC, McLean, VA (US)

(72) Inventors: Bryant YEE, Washington, DC (US); Mykhaylo BULGAKOV, Arlington, VA (US); George BERGERON, Falls Church, VA (US)

(21) Appl. No.: 18/968,143

(22) Filed: Dec. 4, 2024

Related U.S. Application Data
(63) Continuation of application No. 17/667,417, filed on Feb. 8, 2022, now Pat. No. 12,166,750.

(51) Int. Cl. H04L 9/40

(52) U.S. Cl. CPC H04L 63/083; H04L 63/102; H04L 63/104; H04L 63/20

(57) ABSTRACT

Systems and methods for secure access are provided. The secure access system includes a contactless card, a user device, a processor, and a storage device. The processor receives a first authentication request from the user device. Then, the processor transmits a first authentication credential associated with user login data to the user device. Next, the processor receives a second authentication request from the user device. Upon receipt of the second authentication request, the processor transmits a second authentication credential associated with a contactless card to the user device. Then, the processor receives a first code from the user device, and the storage device performs one or more access actions based on the first code.

### CROSS-REFERENCE TO RELATED APPLICATION

The present disclosure is a continuation of and claims the benefit of priority to U.S. patent application Ser. No. 17/667,417, filed Feb. 8, 2022, now U.S. Pat. No. 12,166,750, the contents of which are incorporated herein by reference in their entirety.

### FIELD OF THE DISCLOSURE

The present disclosure relates to systems and methods for secure access of storage.

### BACKGROUND

Electronic commerce is becoming increasingly widespread and common. Likewise, online shopping, where items are purchased online and shipped to the purchasing customer at a residential address, commercial address, or other location, constitutes a growing part of the global economy. In tandem with the rise of online shopping has been the use of storage devices to house packages that the purchasing customer can retrieve at a later time. Secure, authentication-locked containers are common methods of storing valuables. These methods are frequently used to store important documents or packages in a secure housing. Packages, documents, or other valuable items are becoming increasingly common among consumers of online commerce.

The demand for secure containers is increasing, and accordingly there is an increasing need for secure methods to access these containers. Storing valuable items inside of a locked container presents a number of safety concerns, such as unauthorized access. For example, if a container is not properly stored or its security is too weak, then valuable items are at risk of being stolen or lost. As another example, containers located in public spaces such as lobbies or off-site facilities are at risk of being stolen or tampered with by unauthorized parties. As another example, containers located in private spaces such as medicine cabinets or safes are at risk of being accessed by children or other unauthorized parties.

These and other deficiencies exist. Therefore, there is a need to provide systems and methods that overcome these deficiencies to verify customers in a secure and efficient manner.

### SUMMARY OF THE DISCLOSURE

Aspects of the disclosed technology include systems and methods for secure access of storage.

Embodiments of the present disclosure provide a secure access system. The secure access system includes a storage device, a user device, and a card. The storage device includes a memory and a processor. The processor is configured to receive a first authentication request from the user device. After the first authentication request has been received, the processor is configured to transmit a first authentication credential associated with user login data to the user device. Upon receipt of the first authentication credential, the processor is configured to receive a second authentication request from the user device. In response to the second authentication request, the processor is configured to transmit a second authentication credential associated with an entry of a card into a communication field to the user device. Upon receipt of the second authentication credential, the user device is configured to send a first code to the processor. Upon receipt of the first code, the processor is configured to perform one or more actions based on the first code.

Embodiments of the present disclosure provide a method of a secure access system. The method of a secure access system comprises: receiving a first authentication request; transmitting a first authentication credential; receiving a second authentication request; transmitting a second authentication credential; receiving a first code; and performing one or more access actions based on the first code.

Embodiments of the present disclosure provide a non-transitory medium comprising computer executable instructions. The computer executable instructions perform procedures comprising the steps of: receiving a first authentication request; transmitting a first authentication credential; receiving a second authentication request; transmitting a second authentication credential; receiving a first code; and performing one or more access actions based on the first code.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

Various embodiments of the present disclosure, together with further objects and advantages, may best be understood by reference to the following description taken in conjunction with the accompanying drawings. The drawings should not be construed as limiting the present invention, but are intended only to illustrate different aspects and embodiments of the invention.

FIG. 1 is a diagram of a system for a secure access system according to an example embodiment.

FIG. 2A is a diagram of a contactless card according to an example embodiment.

FIG. 2B is a diagram of a contactless card according to an example embodiment.

FIG. 3A is a flow chart illustrating a method of secure access according to an example embodiment.

FIG. 3B is a method flow chart illustrating a method of key diversification according to an example embodiment.

FIG. 4 is a sequence diagram illustrating a method of secure access according to an example embodiment.

FIG. 5 is a diagram of a secure access system according to an example embodiment.

FIG. 6 is a sequence diagram of a secure access system according to an example embodiment.

FIG. 7 is a method diagram of a secure access system according to an example embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present disclosure provides systems and methods for a secure access system.

Benefits of the systems and methods disclosed herein include improved security and efficient access of storage. Example embodiments of the present disclosure provide systems and methods for a secure access system. A contactless card or other device may be tapped to a device (e.g., a smart phone) to engage with the secure access system and method. Accordingly, a delivery person can verify that they are delivering a package to the right person, and the person accepting the package can also verify that the delivery person who is delivering to them is authorized to make the delivery.

In some embodiments, when a contactless card or other device is tapped to a person's phone, certificates signed by an employer (e.g., a courier) can also be transferred. This transfer can be either directly from the contactless card, the person's phone, or indirectly after looking up their identity online.

In some embodiments, when a contactless card is tapped to a package delivery device, the identity of the person who taps the contactless card can be determined and verified to match the addressee of the package. This can also be implemented with host card emulation (HCE) that emulates the contactless card. The address on the package may be a loose address (stored preferences) or tight with digitally signed certificates, or may be scoped to the individual delivery transaction.

Example embodiments of the present disclosure can promote the efficiency and security of transactions, such as package pickup and delivery transactions and the purchase of goods or services subject to age restrictions, quantity restrictions, and other restrictions. Further, the identity verification can be carried out quickly, without degrading the user experience and without the need for consumers, employees, and other personnel to carry identification documents and other materials. It is understood that example embodiments of the present disclosure are applicable to a wide range of purposes where identity verification is required, including, without limitation, package pickup, package delivery, security (e.g., building or restricted area access), and travel (e.g., ticket purchases, plane or train boarding).

Example embodiments of the present disclosure can promote the safety and privacy of the user, such securing the access to safes or medicine cabinets or other storage containers located in a user's private home. The verifications required by the present disclosure secure storage devices from unauthorized parties.

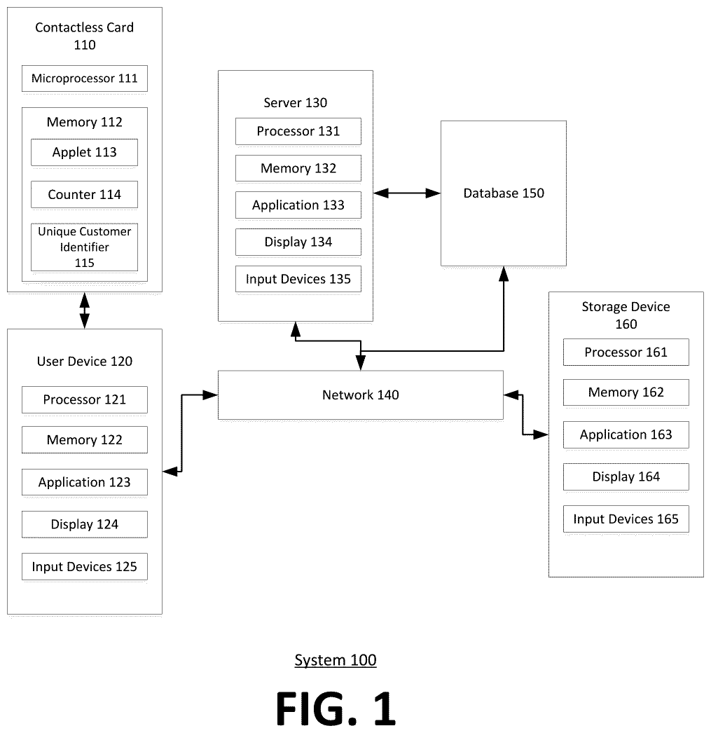

FIG. 1 illustrates a system 100 according to an example embodiment. The system 100 may comprise a contactless card 110, a user device 120, a server 130, a network 140, a database 150, and a storage device 160. Although FIG. 1 illustrates single instances of components of system 100, system 100 may include any number of components.

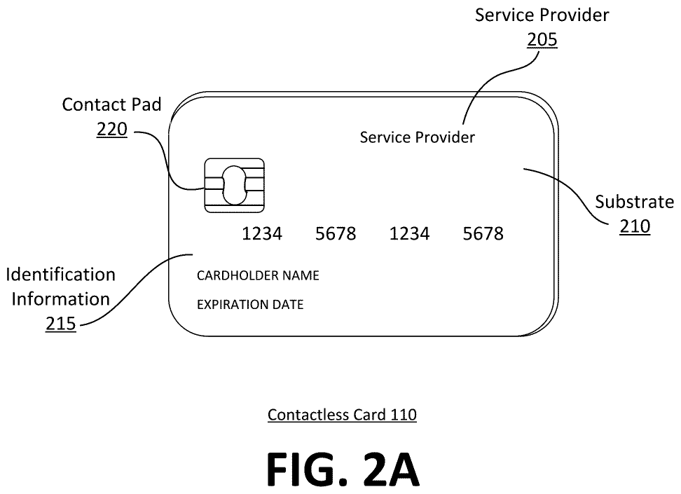

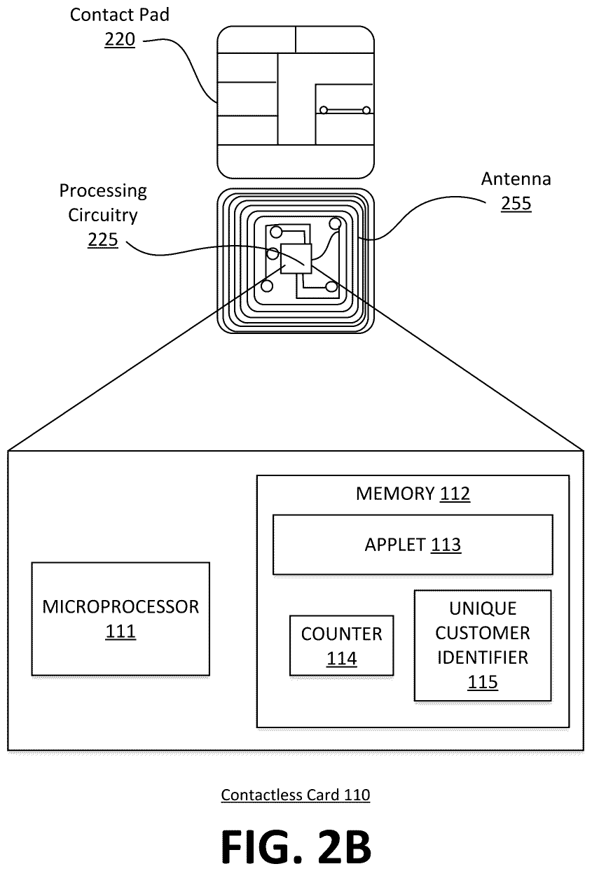

System 100 may include one or more contactless cards 110 which are further explained below with reference to FIGS. 2A-2B. In some embodiments, contactless card 110 may be in wireless communication, utilizing NFC in an example, with user device 120.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the application 133 may be executed to perform receiving web form data from the user device 120 and the storage device 160, retaining a web session between the user device 120 and the storage device 160, and masking private data received from the user device 120 and the storage device 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 120, the server 130, the database 150 and the storage device 160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

System 100 may include a storage device 160. The storage device 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The storage device 160 may include a processor 161, a memory 162, and an application 163. The processor 161 may be a processor, a microprocessor, or other processor, and the storage device 160 may include one or more of these processors. The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the storage device 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the storage device 160. In some examples, the storage device 160 may execute one or more applications, such as software applications, that enable, for example, network communications with one or more components of the system 100, transmit and/or receive data, and perform the functions described herein. Upon execution by the processor 161, the application 163 may provide the functions described in this specification, specifically to execute and perform the steps and functions in the process flows described below. For example, the application 163 may be executed to perform receiving web form data from the user device 120 and the storage device 160, retaining a web session between the user device 120 and the storage device 160, and masking private data received from the user device 120 and the storage device 160. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The storage device 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

FIG. 2A illustrates a contactless card 110 according to an example embodiment.

The contactless card 110 may comprise a payment card, such as a credit card, debit card, or gift card, issued by a service provider 205 displayed on the front or back of the card 110. In some examples, the contactless card 110 is not related to a payment card, and may comprise, without limitation, an identification card, a membership card, a transportation card, or an access card. In some examples, the payment card may comprise a dual interface contactless payment card.

The contactless card 110 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200A may have physical characteristics compliant with the ID-1 format of the ISO/IEC 7810 standard, and the contactless card may otherwise be compliant with the ISO/IEC 14443 standard. However, it is understood that the contactless card 110 according to the present disclosure may have different characteristics, and the present disclosure does not require a contactless card to be implemented in a payment card.

The contactless card 110 may also include identification information 215 displayed on the front and/or back of the card, and a contact pad 220. The contact pad 220 may be configured to establish contact with another communication device, such as a user device, smart phone, laptop, desktop, or tablet computer. The contactless card 110 may also include processing circuitry, antenna and other components not shown in FIG. 2A. These components may be located behind the contact pad 220 or elsewhere on the substrate 210. The contactless card 110 may also include a magnetic strip or tape, which may be located on the back of the card (not shown in FIG. 2A).

FIG. 2B illustrates a contactless card 110 according to an example embodiment.

As illustrated in FIG. 2B, the contact pad 220 may include processing circuitry 225 for storing and processing information, including a microprocessor 111 and a memory 112. It is understood that the processing circuitry 225 may contain additional components, including processors, memories, error and parity/CRC checkers, data encoders, anticollision algorithms, controllers, command decoders, security primitives and tamperproofing hardware, as necessary to perform the functions described herein.

The memory 112 may be a read-only memory, write-once read-multiple memory or read/write memory, e.g., RAM, ROM, and EEPROM, and the contactless card 200B may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 112 may be configured to store one or more applets 113, one or more counters 114, and a customer identifier 115. The one or more applets 113 may comprise one or more software applications configured to execute on one or more contactless cards, such as Java Card applet. However, it is understood that applets 113 are not limited to Java Card applets, and instead may be any software application operable on contactless cards or other devices having limited memory. The one or more counters 114 may comprise a numeric counter sufficient to store an integer. The customer identifier 115 may comprise a unique alphanumeric identifier assigned to a user of the contactless card 110, and the identifier may distinguish the user of the contactless card from other contactless card users. In some examples, the customer identifier 115 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 220 or entirely separate from it, or as further elements in addition to processor 111 and memory 112 elements located within the contact pad 220.

In some examples, the contactless card 110 may comprise one or more antennas 255. The one or more antennas 255 may be placed within the contactless card 110 and around the processing circuitry 225 of the contact pad 220. For example, the one or more antennas 255 may be integral with the processing circuitry 225 and the one or more antennas 255 may be used with an external booster coil. As another example, the one or more antennas 255 may be external to the contact pad 220 and the processing circuitry 225.

In an embodiment, the coil of contactless card 110 may act as the secondary of an air core transformer. The terminal may communicate with the contactless card 110 by cutting power or amplitude modulation. The contactless card 110 may infer the data transmitted from the terminal using the gaps in the contactless card's power connection, which may be functionally maintained through one or more capacitors. The contactless card 110 may communicate back by switching a load on the contactless card's coil or load modulation. Load modulation may be detected in the terminal's coil through interference.

As explained above, the contactless card 110 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

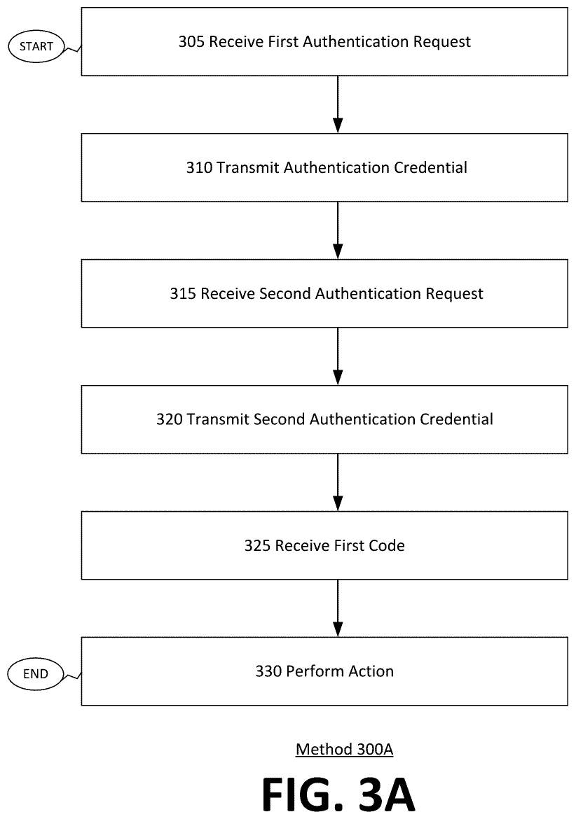

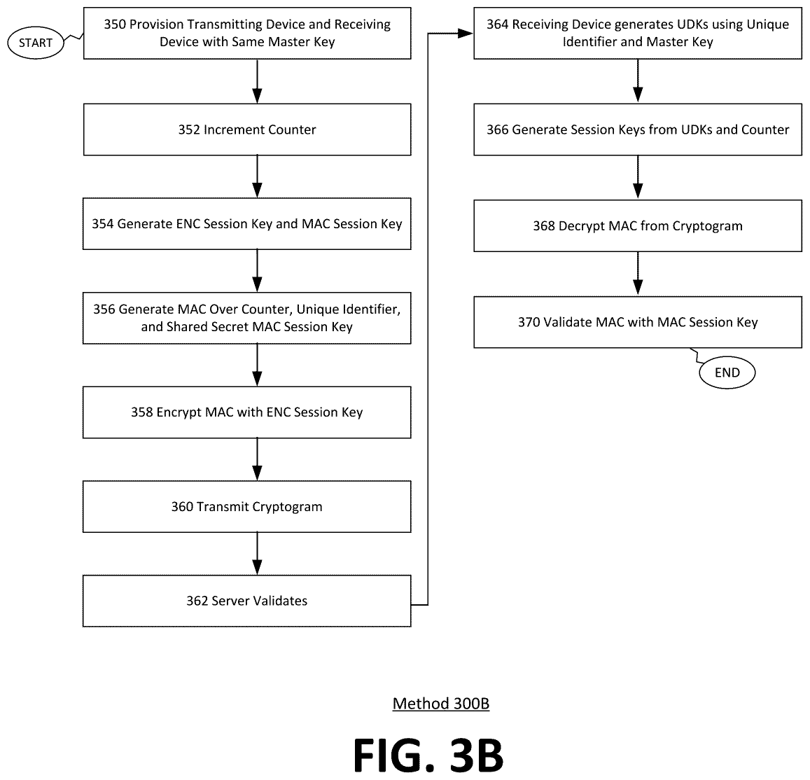

FIG. 3A is a flow chart of method 300A of secure access according to an example of the present disclosure. FIG. 3 can reference the same or similar components as illustrated in FIGS. 1-2.

The method 300A can commence in step 305 where the first authentication request is received. The first authentication request may be transmitted by a user device and may be received by a processor. The processor may be related to the storage device, a server, or another device.

In step 310, the first authentication credential is transmitted to the user device. The first authentication credential may be transmitted by a processor. The processor may be related to the storage device, a server, or another device.

In step 315, the second authentication request is received by the processor. The processor may be related to the storage device, a server, or another device.

In step 320, the second authentication credential is transmitted to the user device. The second authentication credential may be transmitted by a processor. The processor may be related to the storage device, a server, or another device.

The processor may attempt transmission of the first and second authentication credentials up to a predetermined threshold number. For example, the processor may attempt to send the first authentication credential up to a threshold of five attempts if the first four attempts are not satisfied. It is understood that five is an example threshold, and that the processor may attempt transmission five times, less than five times, or more than five times.

The processor may delay the performance of one or more access actions if the attempted transmission of the first and second authentication credentials exceed the predetermined threshold.

The processor may attempt to transmit a third authentication request and to receive, in response to the third authentication request, a third authentication credential associated with biometric data. This biometric data can include one or more predetermined kinds of data including but not limited to voice recognition, fingerprint scanning, handprint scanning, hand-geometry recognition, ear shape recognition, vein pattern recognition, facial recognition, iris recognition, retina recognition, heart-rate recognition, body temperature recognition, and DNA recognition.

In step 325, the first code is received by the processor. The processor may be related to the storage device or some other server. The processor may receive a second code if the first code is not received and inputted within a predetermined time period.

In step 330, the action related to the first code is performed. The action may be performed by the storage device. One or more of the access actions can include opening a safe, closing a safe, unlocking a safe, and locking a safe. As another example, one or more of the access actions can include opening a cabinet, closing a cabinet, unlocking a cabinet, and locking cabinet. As another example, one or more of the actions can include notifying the user that their package has been picked up.

Step 330 may include one or more access actions for a predetermined type of transaction. These transactions may include one or more of the following transactions from the following non-limiting list: cash, credit, debit, other non-cash transactions, point of sale transactions, and other consumer based transactions. It is understood that this list is illustrative and may include other examples of transactions.

Step 330 may include one more access actions for a predetermined time period. For example, the access action may be available for one minute, one hour, or other predetermined time period. After this period elapses, further authentication as described herein may be required to re-perform the access action. Alternatively, if less time is needed for the access action, further authentication as described herein may be required to end the access action prior to the expiration of the predetermined time period.

Step 325 may include one or more actions for authorizing remote access to one or more users. The processor may perform one or more access actions for a smart device, which can include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

FIG. 3B is a flow chart of method 300B of key diversification according to an example of the present disclosure. FIG. 3B can reference the same or similar components as illustrated in FIGS. 1-2.

For example, a sender and recipient may desire to exchange data via a transmitting device (e.g. a user device) and a receiving device (e.g. a storage device and/or a user device). As explained above, it is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device.

The transmitting device and the receiving device may be configured to communicate via NFC, Bluetooth, RFID, Wi-Fi, and/or the like.

The method 300B can begin with Step 350. In step 350, a transmitting device and receiving device may be provisioned with the same master key, such as the same master symmetric key. The transmitting device may be the user device 120. The receiving device may be the contactless card 110. When the transmitting device is preparing to process the sensitive data with symmetric cryptographic operation, the sender may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 352, the transmitting device may take the selected cryptographic algorithm, and using the master symmetric key, process the counter value 114. For example, the sender may select a symmetric encryption algorithm, and use a counter which updates with every conversation between the transmitting device and the receiving device The one or more counters 114 may comprise a numeric counter sufficient to store an integer. The processor may increment the counter one or more times.

In step 354, the transmitting device generates two session keys: one ENC (encryption) session key and one MAC (message authentication code) session key. The transmitting device may encrypt the counter value with the selected symmetric encryption algorithm using the master symmetric key to create a session key.

In step 356, the processor generates the MAC over the counter 114, the unique customer identifier 115, and the shared secret MAC session key. The customer identifier 115 may comprise a unique alphanumeric identifier assigned to a user of the contactless card 110, and the identifier may distinguish the user of the contactless card from other contactless card users. In some examples, the customer identifier 115 may identify both a customer and an account assigned to that customer and may further identify the contactless card associated with the customer's account.

In step 358, the processor encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 360, the processor transmits a cryptogram to the receiving device. The receiving device can the contactless card 110. The cryptogram can include the applet information 113, the unique customer identifier 115, the counter value 114, and the encrypted MAC.

In step 362, the server validates the cryptogram. The server may be a part of the transmitting device or receiving device. Alternatively, the server may be a separate entity.

In step 364, the receiving device generates its own UDKs (unique diversified keys) using the unique customer identifier 115 and the master key. The unique customer identifier 115 is derived from the validated cryptogram. Recall that the receiving device has already been provisioned with the master key.

In step 366, the receiving device generates two session keys: one ENC (encryption) session key and one MAC (message authentication code) session key. The receiving device may generate these session keys from the UDKs and the counter value 114. The counter value 114 can be derived from the cryptogram.

In step 368, the receiving device uses the session keys to decrypt the MAC from the cryptogram sent by the transmitting device. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key.

In step 370, the receiving device validates the MAC with the MAC session key generated in step 366. The receiving device may validate the MAC over the unique customer identifier 115 and the counter value 114.

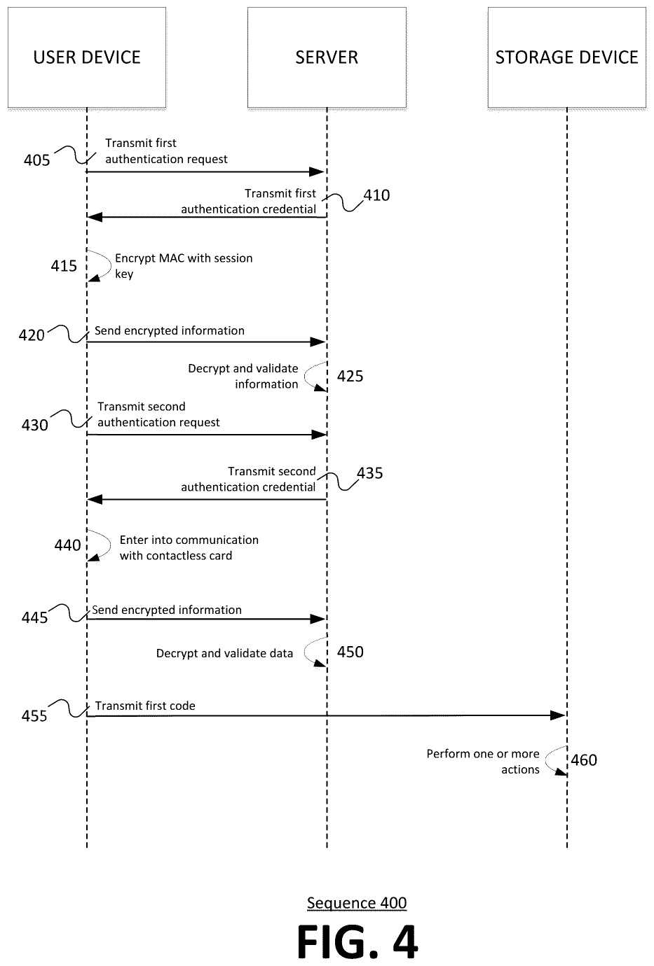

FIG. 4 illustrates a sequence diagram 400 of the secure access system. FIG. 4 can reference the same or similar components as illustrated in FIGS. 1-3.

The sequence 400 can commence in step 405 where the transmitting device (e.g., a user device) transmits the first authentication request to the server. The server may be a part of the storage device. It is understood that the transmitting device may be in data communication with the server via one or more intermediary devices, such as one or more user devices.

In step 410, the server transmits the first authentication credential to the transmitting device.

The processor may attempt transmission of the first and second authentication credentials up to a predetermined threshold number. For example, the processor may attempt to send the first authentication credential up to a threshold of five attempts if the first four attempts are not satisfied. It is understood that five is an example threshold, and that the processor may attempt transmission five times, less than five times, or more than five times.

In step 415, the transmitting device encrypts the information or data necessary to satisfy the first authentication credential. The method of encryption is further explained with reference to FIG. 3B. The first authentication credential can be associated with user login data. It is understood that the user login data can include many different kinds of information, such as identification information, financial information, location information, timing information, or some other kind of information.

In step 420, the transmitting device sends the encrypted information to the storage device. The storage device may include the server.

In step 425, the storage device decrypts and validates the information sent by the transmitting device, thereby validating the first authentication necessary to perform an access action.

In step 430, the transmitting device transmits the second authentication request to the server. The server may be a part of the storage device.

In step 435, the server transmits the second authentication credential to the transmitting device.

The processor may attempt transmission of the first and second authentication credentials up to a predetermined threshold number. For example, the processor may attempt to send the first authentication credential up to a threshold of five attempts if the first four attempts are not satisfied. It is understood that five is an example threshold, and that the processor may attempt transmission five times, less than five times, or more than five times.

The processor may delay the performance of one or more access actions if the attempted transmission of the first and second authentication credentials exceed the predetermined threshold.

In step 440, the transmitting device encrypts the data or information necessary to satisfy the second authentication credential. The method of encryption is further explained with reference to FIG. 3B. The second authentication credential may be associated with a contactless card. It is understood that the user login data can include many different kinds of information, such as identification information, financial information, location information, timing information, or some other kind of information.

In step 445, the transmitting device sends the encrypted information to the storage device. The storage device may include the server.

In step 450, the storage device decrypts and validates the information sent by the transmitting device, thereby validating the second authentication necessary to perform an access action.

In step 455, the transmitting device transmits the first code to the storage device. The processor may receive a second code if the first code is not received and inputted within a predetermined time period.

In step 460, the storage device performs one or more actions related to the first code. One or more of the access actions can include opening a safe, closing a safe, unlocking a safe, and locking a safe. As another example, one or more of the access actions can include opening a cabinet, closing a cabinet, unlocking a cabinet, and locking cabinet. As another example, one or more of the actions can include notifying the user that their package has been picked up.

Step 460 may include one or more access actions for a predetermined type of transaction. These transactions may include one or more of the following transactions from the following non-limiting list: cash, credit, debit, other non-cash transactions, point of sale transactions, and other consumer based transactions. It is understood that this list is illustrative and may include other examples of transactions.

Step 460 may include one more access actions for a predetermined time period.

Step 460 may include one or more actions for authorizing remote access to one or more users. The processor may perform one or more access actions for a smart device, which can include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

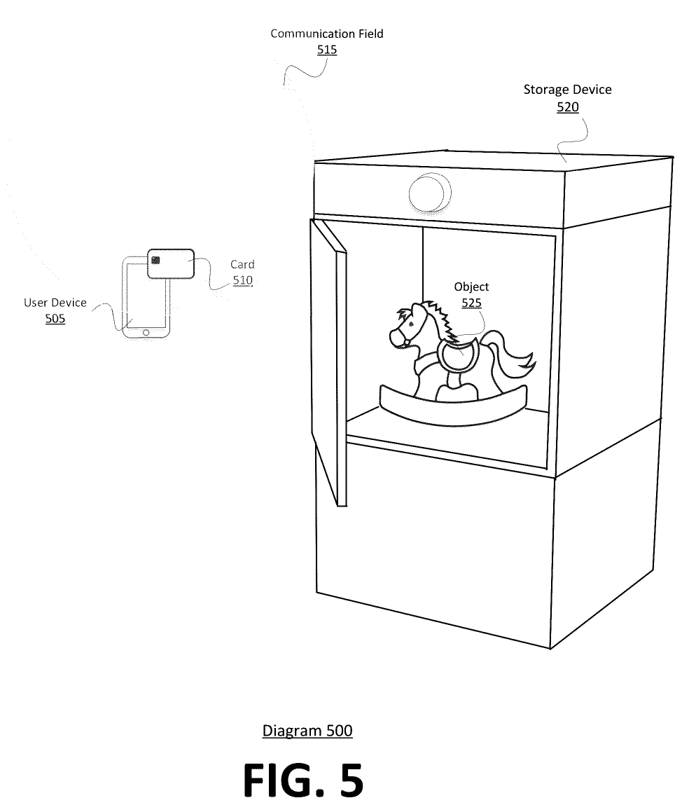

FIG. 5 illustrates a diagram 500 of the secure access system. FIG. 5 can reference the same or similar components as illustrated in FIGS. 1-4.

The diagram 500 may include a user device 505 which are further explained with reference to FIG. 1. The user login data associated with the user device 505 may serve as a first authentication credential. It is understood that the user login data can include many different kinds of information, such as identification information, financial information, location information, timing information, or some other kind of information.

The user device 505 may interact with a contactless card 510 which is further explained with reference to FIGS. 2A-2B. The information associated with the contactless card 510 may serve as a second authentication credential.

When the user device 505 and contactless card 510 satisfy the authentication requirements, information can be shared through a Bluetooth signal or wireless signal 515.

The user device 505 and contactless card 510 can satisfy the authentication requirements requested by the storage device 520 which is further explained with reference to FIG. 1. The storage device 520 can request, receive, and authenticate information stored on either or both the user device 505 and contactless card 510. Once the storage device 520 has authenticated a sufficient amount of information, it may perform one or more actions. In the diagram 500, the storage device 520 performs an action associated with opening a storage locker with a valuable item inside. It is understood that the storage device 520 may include not only storage lockers, but package lockers, medicine cabinets, delivery boxes, mail boxes, P. O. boxes, safes, or any other container used by consumers to store deliveries or otherwise private items.

The storage device 520 may open to allow the user to retrieve an item 525.

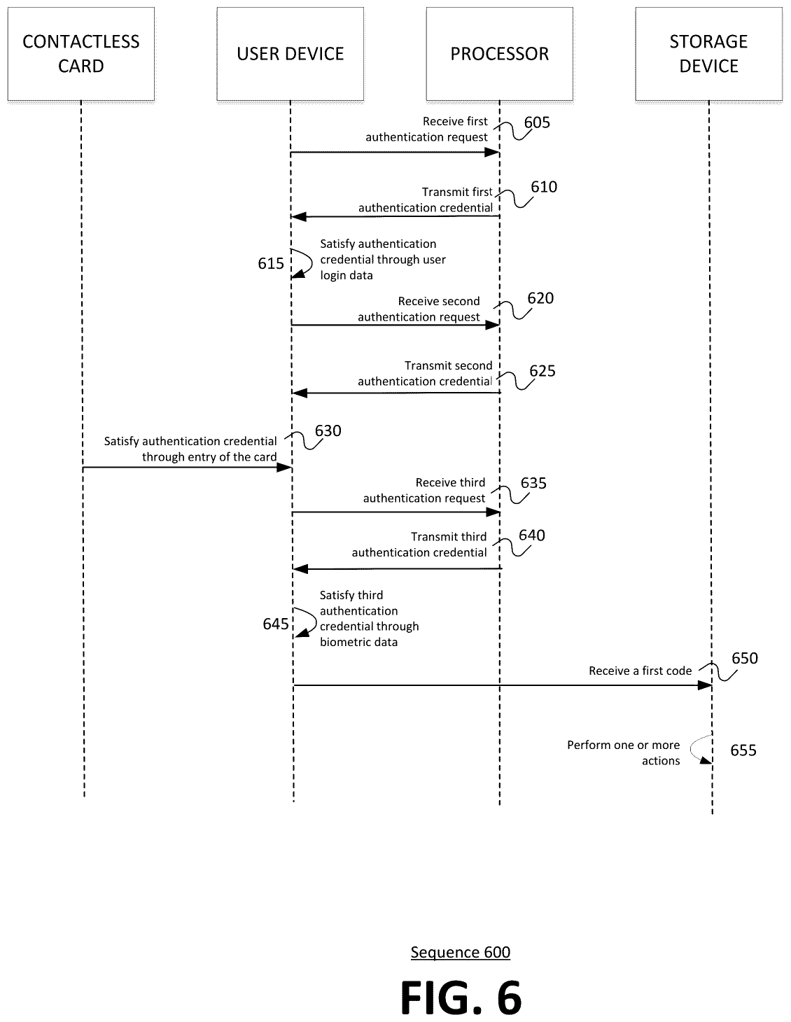

FIG. 6 illustrates a sequence diagram of a secure access system with the typical authentication credentials of user login data, a contactless card, and biometric data which has not previously been illustrated. FIG. 6 is an exemplary process illustrating secure access to a storage device according to one example. FIG. 6 can reference the same or similar components as illustrated in FIGS. 1-5.

It is understood that the method of encryption with reference to FIG. 3B can apply to the sequence 600.

The sequence 600 describes a sequence of actions between a contactless card, a user device, a processor, and a storage device. Contactless cards are further explained with reference to FIGS. 2A-2B. The user device, processor, and storage device are each further explained with reference to FIG. 1.

The sequence 600 can begin with step 605. In step 605, the processor receives a first authentication request from the user device. The processor may be related to the storage device or some other server.

In step 610, the processor transmits a first authentication credential to the user device.

The processor may attempt transmission of the first and second authentication credentials up to a predetermined threshold number. For example, the processor may attempt to send the first authentication credential up to a threshold of five attempts if the first four attempts are not satisfied. It is understood that five is an example threshold, and that the processor may attempt transmission five times, less than five times, or more than five times.

In step 615, the user device satisfies the authentication credential through user login data on the user device or some other processor. It is understood that the user login data can include many different kinds of information, such as identification information, financial information, location information, timing information, or some other kind of information.

In step 620, the processor receives a second authentication request from the user device. The user device is further explained with reference to FIG. 1.

In step 625, the processor transmits a second authentication credential to the user device. The user device is further explained with reference to FIG. 1.

The processor may attempt transmission of the first and second authentication credentials up to a predetermined threshold number. For example, the processor may attempt to send the first authentication credential up to a threshold of five attempts if the first four attempts are not satisfied. It is understood that five is an example threshold, and that the processor may attempt transmission five times, less than five times, or more than five times.

The processor may delay the performance of one or more access actions if the attempted transmission of the first and second authentication credentials exceed the predetermined threshold.

In step 630, the contactless card and the user device interact to satisfy the second authentication credential.

In step 635, the processor receives a third authentication request from the user device.

The user device is further explained with reference to FIG. 1.

In step 640, the processor transmits a third authentication credential to the user device. The user device is further explained with reference to FIG. 1.

In step 645, the user device satisfies the third authentication credential associated with biometric data. This biometric data can include one or more predetermined kinds of data including but not limited to voice recognition, fingerprint scanning, handprint scanning, hand-geometry recognition, ear shape recognition, vein pattern recognition, facial recognition, iris recognition, retina recognition, heart-rate recognition, body temperature recognition, and DNA recognition.

In step 650, the processor receives a first code from the user device. The processor may receive a second code if the first code is not received and inputted within a predetermined time period.

In step 655, the storage device performs one or more actions based on the first code. One or more of the access actions can include opening a safe, closing a safe, unlocking a safe, and locking a safe. As another example, one or more of the access actions can include opening a cabinet, closing a cabinet, unlocking a cabinet, and locking cabinet. As another example, one or more of the actions can include notifying the user that their package has been picked up.

Step 655 may include one or more access actions for a predetermined type of transaction. These transactions may include one or more of the transactions from the following non-limiting list of transactions: cash, credit, debit, other non-cash transactions, point of sale transactions, and other consumer based transactions. It is understood that this list is illustrative and may include other examples of transactions.

Step 655 may include one more access actions for a predetermined time period.

Step 655 may include one or more actions for authorizing remote access to one or more users. The processor may perform one or more access actions for a smart device, which can include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

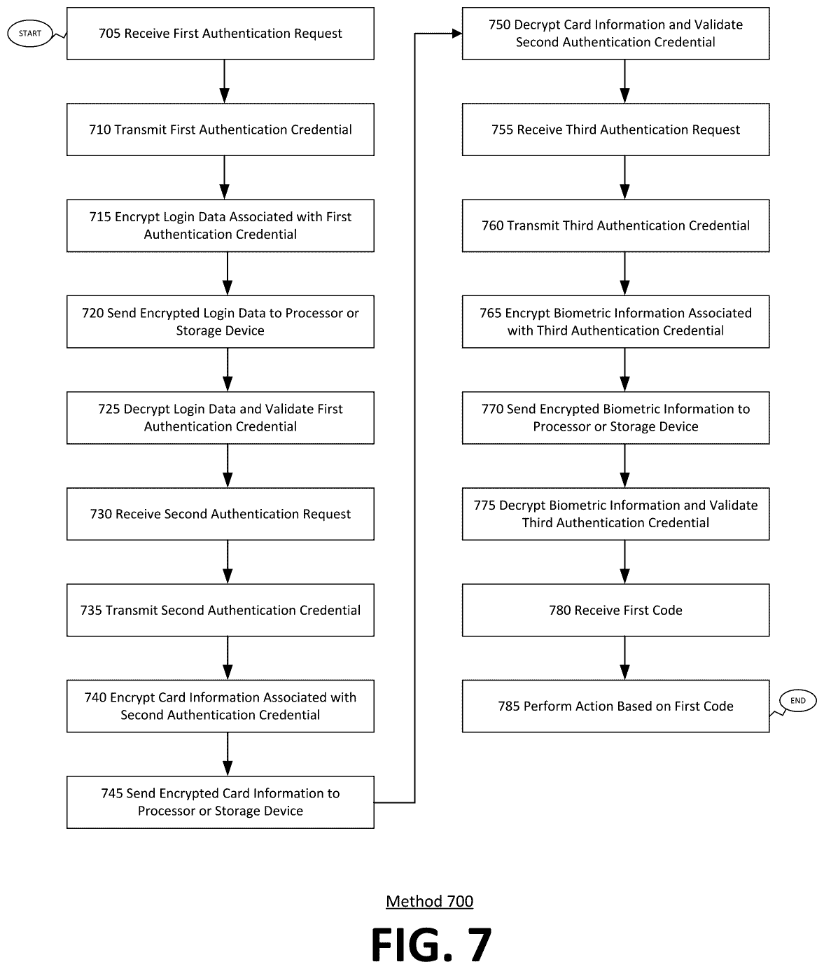

FIG. 7 depicts an exemplary process illustrating secure access to a storage device according to one example. FIG. 7 can reference the same or similar components as illustrated in FIGS. 1-6.

The method 700 describes a typical sequence of actions between a contactless card, a user device, a processor, and a storage device. Contactless cards are further explained with reference to FIGS. 2A-2B. The user device, processor, and storage device are each further explained with reference to FIG. 1. The method of encryption is further explained with reference to FIGS. 3B and 4.

The method 700 can being with step 705, in which the processor receives the first authentication request from a user device.

In step 710, the processor transmits a first authentication credential to the user device.

In step 715, the user device encrypts the login data associated with the first authentication credential.

In step 720, user device sends the now encrypted user login data to the storage device or processor.

In step 725, the processor or storage device decrypts the use login data and validates the first authentication credential.

In step 730, the processor receives a second authentication request from the user device.

In step 735, the processor transmits a second authentication credential to the user device.

In step 740, the user device communicates with a contactless card and encrypts the card information associated with the second authentication credential. It is understood that the information shared between the card and the user device can include many different kinds of information, such as identification information, financial information, location information, timing information, or some other kind of information

In step 745, the user device sends the encrypted card information to the processor or storage device.

In step 750, the processor or storage device decrypts the card information and validates the second authentication credential.

The processor may attempt transmission of the first and second authentication credentials up to a predetermined threshold number. For example, the processor may attempt to send the first authentication credential up to a threshold of five attempts if the first four attempts are not satisfied. It is understood that five is an example threshold, and that the processor may attempt transmission five times, less than five times, or more than five times.

The processor may delay the performance of one or more access actions if the attempted transmission of the first and second authentication credentials exceed the predetermined threshold.

In step 755, the processor can receive a third authentication request from the user device.

In step 760, the processor can transmit a third authentication credential to the user device.

In step 765, the user device can encrypt a user's biometric information associated with the third authentication credential. This biometric data can include one or more predetermined kinds of data including but not limited to voice recognition, fingerprint scanning, handprint scanning, hand-geometry recognition, ear shape recognition, vein pattern recognition, facial recognition, iris recognition, retina recognition, heart-rate recognition, body temperature recognition, and DNA recognition.

In step 770, the user device sends the encrypted biometric information to the processor or storage device.

In step 775, the processor or storage device decrypts the user biometric information and validates the third authentication credential.

In step 780, a first code is received by either or both the processor or the storage device. The processor may receive a second code if the first code is not received and inputted within a predetermined time period.

In step 785, the storage device performs one or more actions based on the receipt of the first code. One or more of the access actions can include opening a safe, closing a safe, unlocking a safe, and locking a safe. As another example, one or more of the access actions can include opening a cabinet, closing a cabinet, unlocking a cabinet, and locking cabinet. As another example, one or more of the actions can include notifying the user that their package has been picked up.

Step 785 may include one or more access actions for a predetermined type of transaction. These transactions may include one or more of the following transactions from the following non-limiting list: cash, credit, debit, other non-cash transactions, point of sale transactions, and other consumer based transactions. It is understood that this list is illustrative and may include other examples of transactions.

Step 785 may include one more access actions for a predetermined time period.

Step 785 may include one or more actions for authorizing remote access to one or more users. The processor may perform one or more access actions for a smart device, which can include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

It is understood that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-20. (canceled)

21. A computer readable non-transitory medium comprising computer executable instructions that, when executed on a processor, perform procedures comprising the steps of:
transmitting a first authentication credential, the first authentication credential associated with user login data;
transmitting a second authentication credential, the second authentication credential associated with an entry of a card into a communication field;
receiving a code; and
performing one or more access actions based on the code.

22. The computer readable non-transitory medium of claim 21, wherein the one or more access actions includes at least one selected from the group of opening a safe, closing a safe, unlocking a safe, and locking a safe.

23. The computer readable non-transitory medium of claim 21, wherein the one or more access actions includes at least one selected from a group of opening a cabinet, closing a cabinet, unlocking a cabinet, and locking a cabinet.

24. The computer readable non-transitory medium of claim 21, wherein the one or more access actions includes transmitting a notification of a package pick up.

25. The computer readable non-transitory medium of claim 21, wherein the one or more access actions are performed for a predetermined time period.

26. The computer readable non-transitory medium of claim 25, the procedures further comprising, after an expiration of the predetermined time period, requiring a further authentication prior to performing the one or more access actions.

27. The computer readable non-transitory medium of claim 25, the procedures further comprising, when the one or more access actions are completed prior to an expiration of the predetermined time period, requiring a further authentication to end performance of the one or more access actions.

28. The computer readable non-transitory medium of claim 21, the procedures further comprising, prior to transmitting the second authentication credential:
receiving a first authentication request, wherein the first authentication credential is transmitted in response to the first authentication request; and
receiving, a second authentication request,
wherein the second authentication credential is transmitted in response to the second authentication request.

29. The computer readable non-transitory medium of claim 28, the procedures further comprising attempting transmission of the first and second authentication credentials up to a predetermined threshold number.

30. The computer readable non-transitory medium of claim 29, the procedures further comprising delaying the performance of one or more access actions if the attempted transmission of the first and second authentication credentials exceeds the predetermined threshold number.

31. The computer readable non-transitory medium of claim 21, wherein:
the one or more access actions are associated with a type of transaction, and
the type of transaction comprises at least one selected from the group of a cash transaction, a credit transaction, a debit transaction, a non-cash transaction, and a point of sale transaction.

32. A system for secure access, comprising:
a processor; and
a memory,
wherein the processor is configured to:
transmit a first authentication credential, the first authentication credential associated with user login data;
transmit a second authentication credential, the second authentication credential associated with an entry of a card into a communication field;
receive a code; and
perform one or more access actions based on the code.

33. The system for secure access of claim 32, wherein the processor and memory are implemented within a storage device.

34. The system for secure access of claim 33, wherein the storage device comprises at least one selected from the group of a storage locker, a package locker, a medicine cabinet, a delivery box, a mail box, a Post Office box, and a safe.

35. The system for secure access of claim 32, wherein the processor and memory are in data communication with a storage device.

36. The system for secure access of claim 32, wherein the processor is further configured to receive a second code if the first code is not received and inputted within a predetermined time period.

37. The system for secure access of claim 32, wherein the processor is further configured to perform the one or more access actions for a predetermined type of transaction.

38. A method, comprising:
transmitting, by a processor, a first authentication credential, the first authentication credential associated with user login data;
transmitting, by the processor, a second authentication credential, the second authentication credential associated with an entry of a card into a communication field;
receiving, by the processor, a code; and
performing, by the processor, one or more access actions based on the code.

39. The method of claim 38, further comprising attempting, by the processor, transmission of the first and second authentication credentials up to a predetermined threshold number

40. The method of claim 39, further comprising delaying the performance of one or more access actions when the attempted transmission of the first and second authentication credentials exceeds the predetermined threshold number
